(19) United States
(12) Patent Application Publication
(10) Pub. No.: US 2004/0097187 A1
(43) Pub. Date: May 20, 2004

(54) Setting up a procedure of a communication taking place between instances and a protocol tester

(76) Inventor: Christian Zander, Berlin (DE)

Correspondence Address: TEKTRONIX, INC., Francis I. Gray, MS 50-LAW, P. Box 500, Beaverton, OR, 97077, US

(21) Appl. No.: 10/692,770

(22) Filed: Oct. 24, 2003

(30) Foreign Application Priority Data
Nov. 15, 2002 (EP) 02025497.5

(51) Int. Cl. H04H 1/00

(52) U.S. Cl. 455/3.01

(57) ABSTRACT

Setting up a procedure of a communication taking place between instances includes the steps executable on a protocol tester of selecting the instances involved in the communication, selecting a protocol layer on the basis of which the communication between the selected instances is to take place, selecting abstract communication interfaces of the protocol layer which are involved in the communication selecting communication data, setting up a communication procedure executable between the instances through the protocol tester on the basis of the various selections with the selection of the communication data being made graphically and with the parameters so selectable being allocated description files that are used for setting up the communication procedure which is executable between the instances, it being possible further to select from several functionalities, each functionality being allocated a description file and optionally a graphic representation, including the ability to expand the number of selectable functionalities by creating a configuration file which is read in and interpreted at the time of the setting-up of the communication procedure between the instances and from which is generatable at compile time an associated code, and entering information into the configuration file including a call name of the additional functionality in the executable code, a display form correlating with the additional functionality on a display of the protocol tester on which it may be selected, and information on a description file which contains the executable source code of the additional functionality.

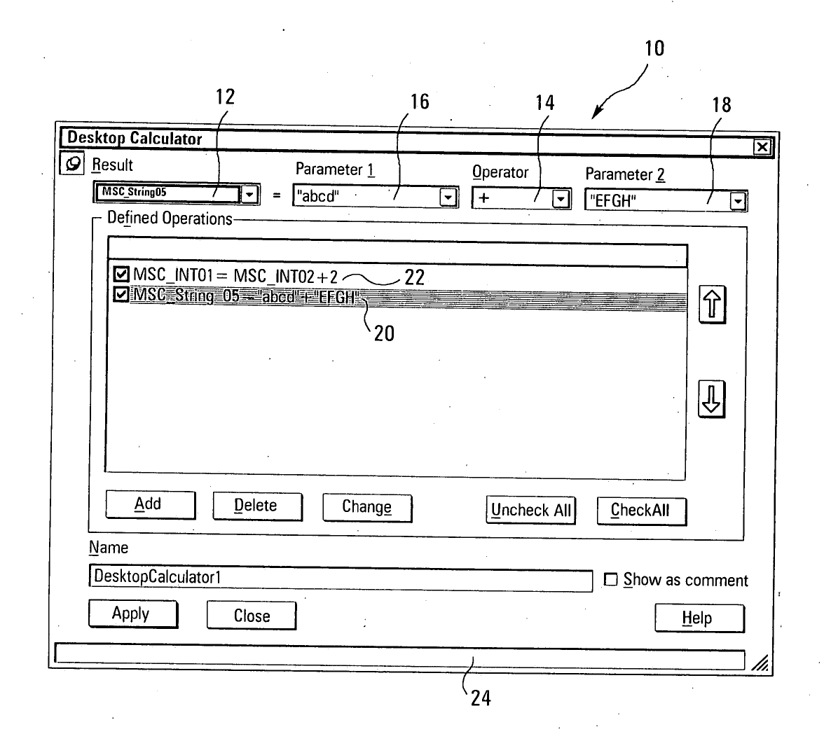

### BACKGROUND OF THE INVENTION

The present invention relates to telecommunications network testing, and more particularly to setting up a procedure of a communication taking place between instances.

A communication procedure setup method, and protocol tester for performing the method, are shown in published European Patent Application EP 1 128 600 (U.S. Patent Application Pub. No. U.S. 2001/0015732 A1) assigned to the assignee of the present invention, which is incorporated herein by reference in its entirety. Using the example of a standardized MSC (Message Sequence Charts) language which serves to graphically display a communication procedure between two instances, the published application describes a transformation of a graphic display into an executable version of a communication procedure. Details on MSC may be found in ITU-T Z 120, which is also incorporated herein by reference in its entirety. This makes it possible, even for users not skilled in the art of programming, to easily create procedures. While the invention described in EP 1 128 600 is a major progress, there nonetheless remain problems—a protocol tester sold under the designation K1297-G20, in which the invention described in EP 1 128 600 has been implemented, has another functional element which provides a user with simple operations. Such element, known as the MSC Desktop Calculator, enables manipulation of simple data types, as for example Integer and String. From such operations, an executable code is generated.

The problem now is that an extension of this functionality to include further operations may only be accomplished by a renewed compilation and linking of the DLLs (Dynamic Link Libraries) involved. Thus any extensions to provide additional operations may only be made by the manufacturer. End users of the protocol tester according to the prior art cannot define operations of their own or refine existing operations. In order to implement another operation, under the prior art it is only possible to include a so-called Forth box into which code may be programmed. However this means that the ability of setting up a communication procedure, as far as possible without any programming knowledge, is lost. Therefore, this is not a satisfactory solution. Alternatively, a new functionality may be implemented by the manufacturer, which means lost time and additional cost, and therefore also is unsatisfactory.

What is desired is to develop a generic method and protocol tester in such a way that new functionalities may be generated by the user—whilst avoiding the use of Forth boxes—without requiring a renewed compilation and linking of the DLLs involved.

### BRIEF SUMMARY OF THE INVENTION

Accordingly the present invention provides setting up of a procedure of a communication taking place between instances based on the realization that a file may be provided as a standard into which new functionalities may once be entered by a specialist, which functionalities are then available to all users. The new functionalities may be created at the manufacturer's, sent by e-mail and incorporated immediately thereafter at the user's site. The advantage over the use of a Forth box lies in a central location of the code. If, for example, the behaviour of a newly defined element is to change, only the stored source code needs to be re-written rather than each affected Forth box in each scenario. Changes of this kind, i.e. changes that result in many consequential changes, frequently occur during the development of new standards and/or protocols. Yet this is the very area of use of a protocol tester, so that this feature is seen as particularly advantageous. Contrary to the Forth box approach, the scenario therefore does not have to be compiled anew when there is a change because the change does not refer to the generated sequence script but to the function underlying a function call. Thus the present invention provides the opportunity to expand MSCs by any elements without there being the need to re-compile DLLs. Entered into a configuration file is, for each functionality parameter to be entered and for the result of the functionality, its name and its type. This way a type test is performed and it is possible that at compile time the appropriate code is generated as a function of the types used because the retrieval and setting of the values in Forth is implemented differently for each parameter type. A display form is a display name of the functionality and/or a graphic symbol, the graphic symbol being allocated a graphic file in which the graphic symbol of the functionality is implemented. The latter measure provides a graphic symbol for the newly created functionality which is just as unproblematic to use in the application, i.e. for setting up a communication procedure, as those for the functionalities already delivered by the manufacturer. For the user the newly created functionality is therefore no different from the standard functions delivered by the manufacturer. The newly created functionality, which is available based on the use of the graphic symbol allocated to it, may be of a mathematic or non-mathematic nature. It may, for example, represent a formula or effect the output of value of a variable in a monitor window. The description file and/or the executable code is preferably formulated in Forth, Jscript or VBScript. The configuration file is preferably implemented as a text file, especially in the INI format or in an XML format. Several, if not all, functionalities created by a user are entered in the configuration file. This way it may be envisaged by the manufacturer as a standard that, at the time of the design, a certain file with a certain name is read in and the functionalities stored in the file are thus made available to the user. The configuration file may also contain information on how many functionalities have been stored in it. This gives the user wishing to supplement this configuration file by additional functionalities a very quick overview. As a result the program receives information on the number of functions for which it may search the configuration file. If it results from the introductory part of the first function that this is not the function sought, the program may abort and proceed with the reading of another configuration file. This makes it possible to save computation time. For the implementation of the functionality created by the user, a call of the functionality created by the user is inserted with its call name into the executable source code. Prior to the call, the parameters required by the functionality created by the user may be handed over, and after the call the result of the functionality may be handed over. The reading-in of the description file may occur by way of an “include” command. Further the instances involved in the communication are graphically selected, the protocol layer is graphically selected, and/or abstract communication interfaces of the protocol layer are graphically selected, with the parameters selectable during this process being allocated description files for setting up the procedure of the communication that is executable between the instances. The abstract communication interfaces preferably are SAPs (Service Access Points). The communication data preferably are PDUs (Protocol Data Units) and/or ASPs (Abstract Service Primitives). The communication data selecting may include graphically selecting a data format and graphically setting up a communication sequence between the instances involved. Even if new functionalities are made available by the measures mentioned, source code may be entered during the graphical set up of the communication sequence.

The objects, advantages and other novel features of the present invention are apparent from the following detailed description when read in conjunction with the associated claims and attached drawing.

### BRIEF DESCRIPTION OF THE SEVERAL VIEWS OF THE DRAWING

The FIGURE is a plan view of a user interface on a display of a protocol tester according to the present invention.

### DETAILED DESCRIPTION OF THE INVENTION

Referring now to the FIGURE, a user interface 10 on a display of a protocol tester performing a functionality created according to the present invention is shown where a variable MSC_String 05, shown in window 12, is allocated a value which results from a link, which is shown in window 14, of a parameter shown in window 16 with a parameter shown in window 18, in the present case the functionality

MSC_String 05 =“abcd”+“EFGH”

is shown in line 20. The functionality shown above that, in line 22, is

MSC_{—}INT01 =MSC_{—}INT02+2

and it too, i.e. like the functionality shown in line 20, is not contained in a version supplied by the manufacturer of the protocol tester and therefore has to be created by the user. The associated program sequences are shown in Annex A1.

Annex A1 initially describes a configuration file, which in this case has the designation “MSC-DC.config”. The number of functions stored in the configuration file, “numberoffunctions”, is two. These include a first functionality “function_{—}0” and a second functionality “function_{—}1”. In case a graph representing the first functionality is stored, the following is inserted at the end of the definition of the first functionality:

graphic=c:\temp\bla.jpg.

Accordingly in file bla.jpg a corresponding graph is stored in the jpg format.

The structure of the two functionalities is identical. The “displayName” is given as “+”, and is displayed in window 14. A function call name in a description file to be created by the user is indicated as “$MSC$_Sum, which is described in more detail below with the designation “DC.4th”. The name and the storage location of the description file is “4th=c:\temp\DC.4th”. Parameter 1 is of the MSC integer type or is a constant and is an “addent”, the value of which is shown in window 16. A request to the user, which is displayed in area 24 of the user interface 10, provides a hint as to what is to be entered—an integer value or a numeric variable. Corresponding information for parameter 2 is described with the value being shown in window 18. The result of the first functionality leads to the following display in the status line in window 24:

“sum=addend+addend”.

The second functionality has the function call name “$MSC$_Concat” and in terms of the structure corresponds to the first functionality, described above in more detail. The code which is inserted in the executable script is shown following the descriptions of the two functionalities starting with the description file “DC.4th”, described in more detail below. The designation of the chart is the document segment “Sum”. The first parameter obtained is “MSC_INT2”, and the second parameter is the number “2”. With the call of “$MSC$_Sum” there is a branching into an associated part of the description file, namely into the code “: $MSC$_Sum+”. The event with the designation “MSC_INT1” is stored back. The same applies to the functionality “$MSC$_Concat” correspondingly. The first and the second parameters, “abcd” and “EDFG”, are read in. The corresponding functionality of the description file is called, namely “: $MSC_ConCat”, and the result is stored back. The description file “DC.4th” gives the two functionalities listed in the configuration file.

Thus the present invention provides a sequence for creating a new functionality by first expanding the configuration file to include the corresponding functionality; and then creating a description file to which reference is made in the function description of the configuration file. By these measures, which may be supplemented to include the generation of a graphics file with a graphic symbol for the newly created functionality, an executable code is generated.

While the present invention is described with MSC as an example for the description language, it is evident to one skilled in the art that the invention is also applicable to other description languages.

Annex A1:

MSC-DC.config:

-->snip
[General]
numberoffunctions=2
[function_0]
displayName=+
functioncall=$MSC$_Sum
4th=c:\temp\DC.4th
parameter1.types=MSC_int, constant_int
parameter1.display=addent
parameter1.hint=Please enter an integer value or select a numeric
variable
parameter2.types=MSC_int, constant_int
parameter2.display=addent
parameter2.hint=Please enter an integer value or select a numeric
variable
result.types=MSC_int
result.display=sum
result.hint=Please select a numeric variable
[function_1]
displayName=+
functioncall=$MSC$_Concat
4th=c:\temp\DC.4th
parameter1.types=MSC_String, constant_string
parameter1.display=addent
parameter1.hint=Please enter a string value or select a string
variable
parameter2.types=MSC_String, constant_string
parameter2.display=addent
parameter2.hint=please enter a string value or select a string
variable
result.types=MSC_string
result.display=sum
result.hint=Please select a string variable
<--snap
DCDemo.4th
-->snip
( . . . )
( >>>>>>>>>> Commands <<<<<<<<<< )
include pc:boot:c:\temp\DC.4th
( . . . )

\----- document segment ‘Sum’ -----
2 STATE_INIT{

“ Desktop Calculator ‘DesktopCalculator1’ start ” “

Sum/TC_1: ” 2 $MSC$_TraceDCalculator $MSC$_TraceMsgArray

( start Desktop Calculator ‘DesktopCalculator1’ )

( MSC_INT01 = MSC_INT02 + 2 )
MSC_INT2 @
2
$MSC$_Sum
MSC_INT1 !
( MSC_String05 = “abcd” + “EFGH” )
“ abcd”
“ EFGH”
$MSC$_Concat
MSC_String5 $MSC$_!String

( end Desktop Calculator ‘DesktopCalculator1’ )
“Desktop Calculator ‘DesktopCalculator1’ end ” “ Sum/TC_1:

” 2 $MSC$_TraceDCalculator $MSC$_TraceMsgArray

$MSC$_DefaultFlagGet 0= IF

0 $MSC$_GetNextState 0 $MSC$_NewState

ELSE

$MSC$_ReturnDefaultChart

THEN

}STATE_INIT

( . . . )
<--snap
DC.4th
-->snip
( . . . )
: $MSC$_ConCat ( from-counted-string to-counted-string -- tmpstr )

| LOCALS\| tmpstr dst src \| | |
|---|---|
| src tmpstr !String | ( move first string to |

tmpstr )

dst 1+ tmpstr src C@ + 1+ dst C@ CMOVE ( append second string )
src C@ dst C@ + tmpstr C!

;
( . . . )

| | |
|---|---|
| : $MSC$_Sum + ; | ( value value -- value ) |

( . . . )
<--snap

What is claimed is:

1. A method of setting up a procedure of a communication taking place between instances which is executable on a protocol tester of the type including the steps of selecting the instances involved in the communication, selecting a protocol layer on the basis of which the communication between the selected instances is to take place, selecting abstract communication interfaces of the protocol layer which are involved in the communication, selecting communication data, setting up a communication procedure executable between the instances through the protocol tester based on the several selecting steps, with the communication data selecting step being made graphically, with the parameters so selectable being allocated description files which are used in the setting up step, and with the possibility of selecting from a plurality of functionalities, each functionality being allocated a graphic representation and a description file, further comprising the steps of:
creating a configuration file which is read in and interpreted at the time of the setting-up the communication procedure between the instances and from which is generatable at compile time an associated code; and
entering information into the configuration file including a call name of an additional functionality in the executable code, a display form correlating with the additional functionality on a display on which it may be selected, and information on the description file which contains the executable source code of the additional functionality.

2. The method according claim 1 wherein for each parameter of the additional functionality to be entered and for the result of the additional functionality is also entered into the configuration file a name and a type.

3. The method according claims 1 or 2 wherein the display form is selected from the group consisting of a display name of the additional functionality and a graphic symbol for the additional functionality, the graphic symbol being allocated a graphic file in which the graphic symbol of the additional functionality is implemented.

4. The method according to claim 1 wherein the description file and/or the executable code are formulated in Forth, Jscript or VBScript.

5. The method according to claim 1 wherein the configuration file is implemented as a text file selected from the group consisting of an INI format and an XML format.

6. The method according to claim 1 wherein the additional functionality is entered in the configuration file.

7. The method according claim 6 wherein the configuration file further includes information on how many functionalities are stored in it.

8. The method according to claim 1 wherein for the implementation, into the executable source code of the additional functionality a call of the additional functionality is entered together with its call name.

9. The method according claim 8 wherein prior to the call the parameters required by the additional functionality are handed over, and after the call the result of the additional functionality is handed over.

10. The method according to claim 1 wherein reading-in of the description file occurs via an include command.

11. The method according to claim 1 wherein the instances involved in the communication are graphically selected, the protocol layer is graphically selected and/or the abstract communication interfaces of the protocol layer are graphically selected.

12. The method according to claim 1 wherein the abstract communication interfaces comprise SAPs (Service Access Points).

13. The method according to claim 1 wherein the communication data is selected from the group consisting of PDUs (Protocol Data Units) and ASPs (Abstract Service Primitives).

14. The method according to claim 1 wherein the communication data selecting step comprises the steps of:
d1) graphically selecting a data format and;
d2) graphically setting up a communication sequence between the instances involved.

15. The method according claim 14 wherein in step d2) the source code is enterable.

17. A protocol tester of the type having means for selecting the instances involved in the communication, means for selecting a protocol layer on the basis of which the communication between the selected instances is to take place, means for selecting abstract communication interfaces of the protocol layer which are involved in the communication, means for selecting communication data, and means for setting up a communication procedure executable between the instances through the protocol tester based on the several selecting means, with the communication data selecting means including graphic selection means with the parameters selectable by them being allocated description files which may be used by the setting-up means for setting up a communication procedure which is executable between the instances, and having the possibility of selecting from a plurality of functionalities, each functionality being allocated a graphic representation and a description file further comprising:
means for creating a configuration file which may be read in and interpreted at the time of the setting-up of the communication procedure between the instances and from which is generatable at compile an associated code; and
means for entering information into the configuration file including a call name of an additional functionality in the executable code, a display form correlating with the additional functionality on a display on which it may be selected, and information on the description file which contains the executable source code of the additional functionality.
